(19) United States
(12) Patent Application Publication
(10) Pub. No.: US 2009/0126467 A1
(43) Pub. Date: May 21, 2009

(54) WASHING DEVICE FOR LIQUID CHROMATOGRAPHY INJECTORS

(75) Inventors: Giacinto Zilioli, Rodano (IT); Paolo Magni, Rodano (IT); Stefano Pelagatti, Rodano (IT)

Correspondence Address: LUCAS & MERCANTI, LLP, 475 PARK AVENUE SOUTH, 15TH FLOOR, NEW YORK, NY, 10016, US

(73) Assignee: THERMO ELECTRON S.P.A., Rodano (IT)

(21) Appl. No.: 12/095,606

(22) PCT Filed: Sep. 6, 2006
(86) PCT No.: PCT/IT2006/000644

§ 371 Date: Aug. 27, 2008

(51) Int. Cl. G01N 30/20

(52) U.S. Cl. 73/61.55

(57) ABSTRACT

The invention concerns a device for washing the injector in a liquid chromatography equipment, comprising a sealed passage for the injection needle and, upstream, a mobile valve for alternatively connecting said passage with the outside for introduction of the needle, or with at least one source of washing fluid.

### FIELD OF THE INVENTION

The present invention concerns a device for washing the injector in a liquid chromatography analysis equipment.

In modern chromatographic analysis equipments it is increasingly important to be sure of introducing into the chromatograph samples, generally in very small quantities, without any contamination, in particular contamination due to samples previously analysed. To ensure this, it is important, before each analysis, to wash the sample introduction equipment and the injection device in general.

### PRIOR ART

A device of this type has already been proposed for HPLC (High Pressure Liquid Chromatography) injectors, described in EP 1275957 and U.S. Pat. No. 6,526,812. This device consists essentially of a body with an internal chamber which can be connected to a source of washing fluid and which can be accessed via an injection needle which is inserted through a duct external to the chamber and passing through the chamber until it reaches a passage for injection of the samples. This passage is shaped so as to provide a seal on the outer surface of the needle, obviously when the latter is inserted during use.

The duct for insertion of the needle is obtained in a fixed part of the device, upstream of said chamber, with the positioning of a seal that can be penetrated by the needle between said duct and the chamber. Again according to the patents referred to, the penetrable seal is made of an elastic material (elastomer) and can be a so-called duckbill valve or a piercable partition. Lastly, it is possible to perform washing with different fluids, present in different containers that can be selected with one or more valves.

This embodiment has some problems at operating level as the duckbill valves have a limited working life and, like the partitions, can release downstream particles that have been detached during insertion of the needle; these particles are obviously contaminating and could obstruct the ducts of the fluid circuit. Furthermore, there could be chemical incompatibilities between the elastomeric materials and the solvents used for the washing.

### SUMMARY OF THE INVENTION

To avoid these and other drawbacks connected in particular with the use of a piercable elastomer seal, the invention proposes a washing device for injectors in liquid chromatography equipments having the characteristics of claim 1.

### FIGURES

The invention will now be described with reference to a preferred embodiment, illustrated by way of example in the accompanying drawings, in which:

FIGS. 1 and 2 are schematic axial sections of the device according to the invention in an injection position and a washing position respectively, when only one washing fluid is scheduled.

FIGS. 3 and 4 are schematic illustrations of an injection apparatus for HPLC equipment provided with the washing device according to the invention during the injection and washing phases respectively.

FIGS. 5, 6 and 7 schematically illustrate a washing device according to the invention with two solvents, in the three possible operating positions.

### EMBODIMENTS OF THE INVENTION

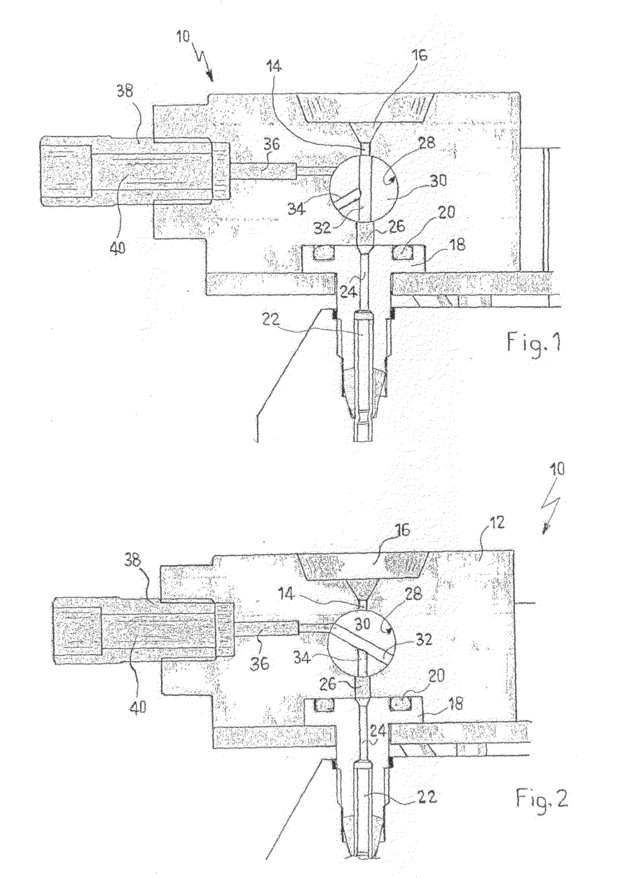

With reference firstly to FIGS. 1 and 2, the washing device 10 illustrated in them consists essentially of a block 12 made of a metallic material, for example, in which a duct 14 is obtained with lead 16 for the introduction of a needle (not shown) from the outside of the equipment.

In its lower part, the block 12 is seal-connected 20 to an elongated component 18 which contains, inside, a passage 24 for the needle or other injection means, aligned with the upper duct. The lower part of the passage 24, indicated by 22, is provided internally with a coating designed to provide a seal with the outer surface of the needle or similar injection device, in a known manner, obviously when said needle is present.

Upstream of the passage 22, 24, the block 12 has a short duct 26 connected and aligned with said passage 22, 24, which ends, like the duct 14, in a valve seat 28, for example a cylindrical, are obtained in the block 12. Inside said valve seat 28 a valve body 30, also cylindrical, is seal-fitted, arranged rotating around its axis to be set to a plurality of positions, in this case two positions, in which two different ways 32 and 34 obtained in the valve body are provided to define two different connections.

The block 12 has a duct 36 which leads at one end to the valve seat 28 and at the other is connected to a tank 38 containing a washing fluid 40.

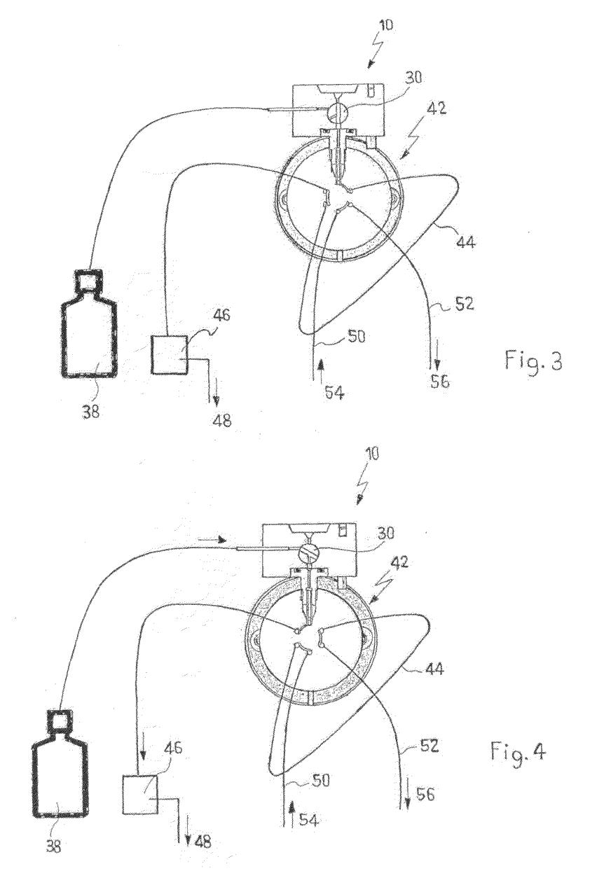

When the valve body 30 is arranged in the position illustrated in FIG. 1, the ducts 14, 26 and the passage 22, 24, aligned with each other, are connected to each other by means of the way 32 to permit the passage of the injection needle, which provides a seal in 24 and permits injection of the sample. When the needle is removed, the valve body 30 is rotated to the position shown in FIG. 2, in which the ways 30 and 32 of the valve body connect the tank 38 to the duct 26 and the passage 22, 24, now free, to perform the washing operation. The washing liquid 40 is preferably extracted from the tank 38 by means of a suction pump, connected as shown in FIGS. 3 and 4. A so-called sampling valve 42, consisting essentially of a multi-way multi-position valve (typically 6 ways and 2 positions), is fitted in the device 10 illustrated in the figures.

In the injection position of FIG. 3, the sample injected by means of a syringe is transferred via the valve 42 to the sampling loop 44. At the same time, the mobile phase coming in 54 from the HPLC pump via the duct 50 passes through the valve 42 and is sent in 56 to the separation column, via the duct 52.

In the subsequent phase, illustrated in FIG. 4, the valve 42 is rotated so that the sample remained in the loop 44 is sent to the column by the mobile phase driven by the HPLC pump. Simultaneously the injector is washed by means of a micropump 46, preferably a washing suction micropump, following displacement of the valve body 30 of the device 10.

In the position illustrated of the valves 28, 30 and 42, the washing suction micropump 46 is connected to the outlet of the passage 22, 24, and the latter is fed with the washing fluid coming from the tank 38, as schematised in FIGS. 3 and 4. Lastly, the micropump delivery is in turn connected to an outlet duct 48.

If several washing fluids are required, for use alternatively or in succession, the valve body 30 is modified in order to provide for example three (or more) ways with three or more operating positions, so that washing fluid can be drawn both from the duct 36 (FIGS. 1 and 2) and from one or more further ducts 36′ obtained in the block 12 and connected to washing fluid tanks different from the first one.

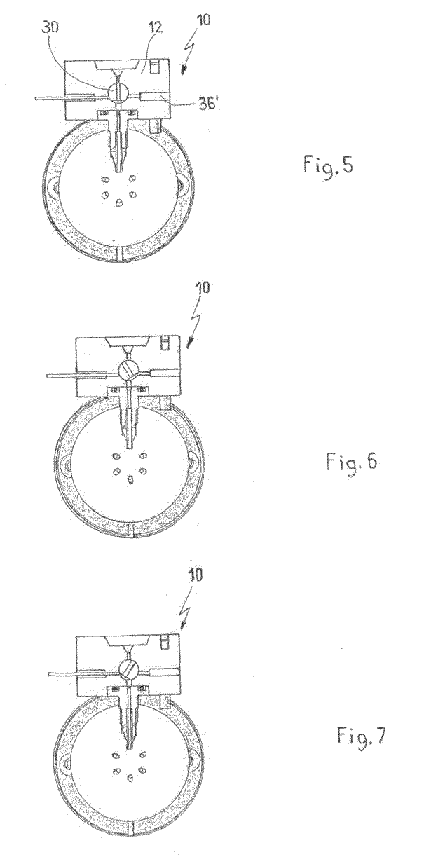

In the case of two different washing fluids, FIGS. 5, 6 and 7 illustrate the positions of the valve 30, respectively for performing injection, washing with the fluid coming from the duct 36 and washing with the fluid coming from the duct 36′. It should be noted that this is achieved with one single suction pump 46 and with the some valve 28, 30 as the one scheduled for injection/washing commutation, without the need for further valves or other mobile components.

Alternatively washing with several fluids can be provided by including a further multi-position selector valve upstream of the washing device.

1) A device for washing the injector in liquid chromatography analysis equipment, of the fixed installation type, sealed upstream of the injector and comprising a passage for the needle or other injection means able to provide a hydraulic seal on the outer wall of the needle and at least one source of washing fluid suitable for communicating with said passage, characterised in that upstream of said passage a valve is positioned having at least two ways and at least two positions, the mobile body of which can be placed in a first position in which the outside of the valve communicates with said passage for introduction of the needle or means for injecting the sample in the injector, and in at least one second position in which said at least one source of washing fluid communicates with said passage.

2) A device as claimed in claim 1, characterised in that the mobile body of said valve has several ways and/or several positions to provide selective communication of each of a plurality of sources of washing fluid with said passage towards the injector.

3) A device as claimed in claim 1, characterised in that a suction pump connected downstream of said passage is provided for the washing fluid(s).

4) A device as claimed in claim 1, characterised in that a delivery pump connected upstream of said passage is provided for the washing fluid(s).

5) A device as claimed in claim 1, characterised in that the mobile body of the valve consists of a cylindrical element inside of which one or more ducts are formed and which is subject to a sealed rotation in a relative fixed valve seat.

6) A device as claimed in claim 5, characterised in that it comprises motor means for controlling the rotations of the cylindrical mobile body.

7) A device as claimed in claim 5, characterised in that the rotating valve body is rotated in a coordinated manner with the rotations of the sampling valve of the liquid chromatography analysis equipment.
